(19) United States
(12) Patent Application Publication
(10) Pub. No.: US 2008/0289514 A1
(43) Pub. Date: Nov. 27, 2008

(54) Regeneration Unit

(75) Inventor: Angelo Speranza, Surrey (GB)

Correspondence Address: DAVIS BUJOLD & Daniels, P.L.L.C., 112 PLEASANT STREET, CONCORD, NH, 03301, US

(73) Assignee: BURLODGE LIMITED, Surbiton, Surrey (GB)

(21) Appl. No.: 12/095,336

(22) PCT Filed: Nov. 29, 2006
(86) PCT No.: PCT/GB2006/004452

§ 371 Date: May 29, 2008

(30) Foreign Application Priority Data
Nov. 29, 2005 (GB) 05 24283.9

(51) Int. Cl. A47J 39/00

(52) U.S. Cl. 99/468

(57) ABSTRACT

A regeneration unit characterized by a housing (11), a compartment (21) in the housing divided into first and second working volumes (22, 23) separated by a partition (24) whose position within the compartment (21) can be varied so as to vary the relative sizes of the two working volumes (22, 23), and a control mechanism whereby a flow of air can be directed into each working compartment independently so that the temperature level and time of heating or cooling of material contained in the first working volume (22, 23) is independent of a temperature level and a time of heating or cooling of material contained in the second working volume (23, 22). Typically, the unit is further characterized in that each working volume (22, 23) is incorporated in a closed flow path which incorporates a mechanism (26, 27) for displacing air around the flow path; and heat transfer mechanism for heating or cooling air displaced around the flow path.

### TECHNICAL FIELD

This invention relates to a regeneration unit which term can be taken to include a cooker and or a refrigeration unit or a combination thereof whether static or mobile.

### DISCLOSURE OF INVENTION

According to the present invention there is provided a regeneration unit having:
a housing;
a compartment in the housing divided into two working volumes by a partition whose position within the compartment can be varied so as to vary the relative sizes of the two working volumes; and
a control means whereby a flow of air can be directed into each working compartment independently so that the temperature level and time of heating or cooling of material contained in one working volume is independent of temperature level and time of heating or cooling of material contained in the other working volume.

According to a first preferred version of the present invention each working volume is incorporated in a closed flow path which incorporates: means for displacing air around the flow path; and heat transfer means for heating or cooling air displaced around the flow path.

According to a second preferred version of the present invention or of the first preferred version thereof the regeneration unit is equipped with programmable means for controlling and/or monitoring operation of the unit.

According to a third preferred version of the present invention of any preceding preferred version thereof the regeneration unit is provided with castors or other means by which the unit can he made mobile.

### BRIEF DESCRIPTION OF DRAWINGS

An exemplary embodiment of the invention will now be described with reference to the accompanying drawings of a regeneration trolley for use in distributing meals (in this case in a hospital) of which:

FIG. 1 is a perspective view from above and one end of a first side of the trolley;

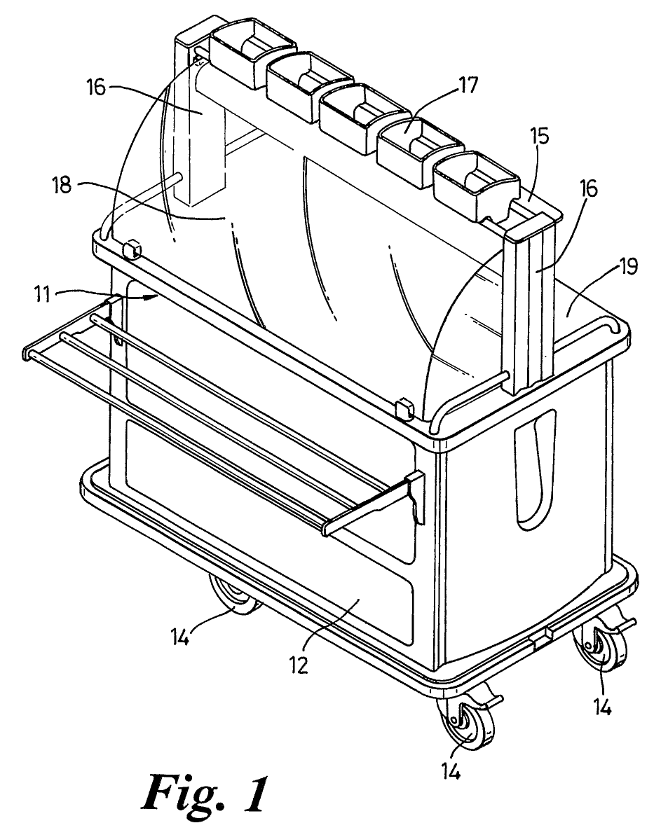

FIG. 2 is a similar view of a second side of the trolley with access door closed;

FIG. 3 is a view of the second side of the trolley with access door open to reveal part of the interior.

### MODE FOR CARRYING OUT THE INVENTION

The drawings variously show a trolley 11 having a first side 12 and a second side 13. The trolley is mounted on castors 14 to allow for the trolley to be readily moved between working locations. In order to provide working power the trolley 11 is readily connected to a mains power supply. To provide for movement of the trolley 11 and contents between locations the mains power is disconnected the trolley is provided with effective insulation to limit heat loss.

The trolley 11 is provided with a overhead storage rack 15, with side arms 16, for removable individual containers, such as container 17, for cutlery or other items or materials used in the course of distributing food carried by means of the trolley. A transparent cover 18 is pivoted on lower ends of side arms 16 to display items carried on working surface 19 of the trolley 11.

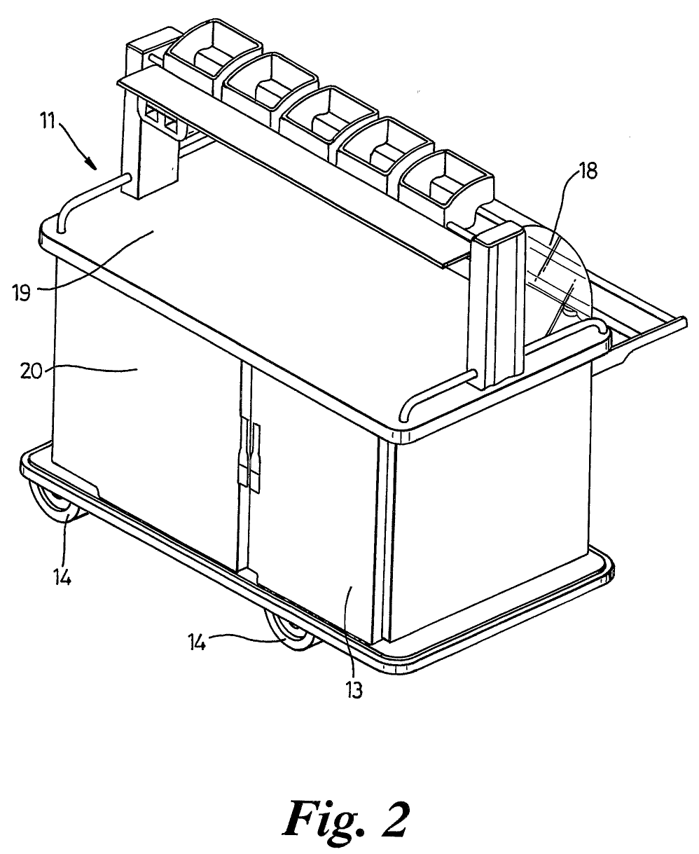

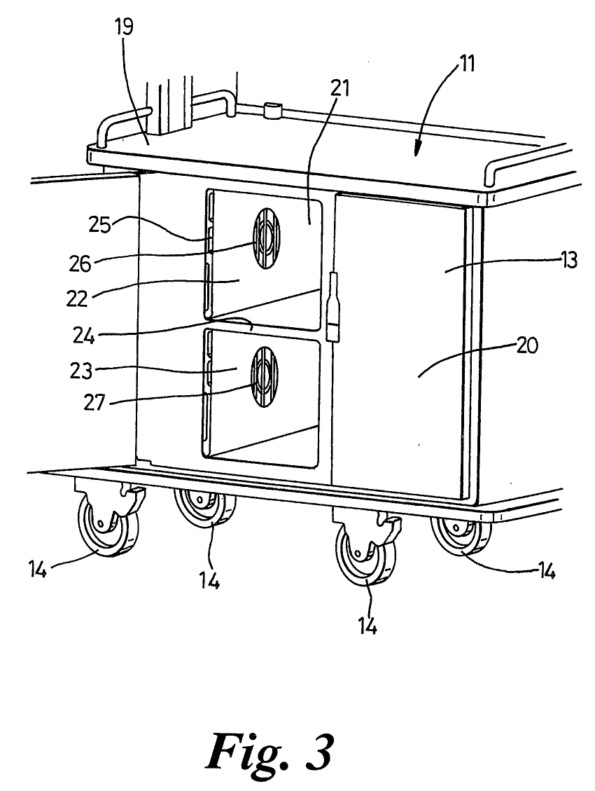

Access door 20 is shown closed in FIG. 2 and open in FIG. 3. Compartment 21 in the trolley 11 provides a working volume made up of upper oven 22 and lower oven 23 separated by divider 24 which is located at its corners by means of slotted strip, typically strip 25. By this means the relative sizes of the upper oven 22 and lower oven 23 can be varied in dependence on the foodstuffs to be regenerated.

Air at a predetermined temperature is fed into upper oven 22 by way of first fan 26. The upper oven 22 forms part of a closed circuit around which the first fan 26 can drive air heated or cooled by way of a heat transfer means (not shown) in the closed circuit.

The lower oven 23 forms part of a further closed circuit around which second fan 27 can drive air heated or cooled by way of a heat transfer means (not shown) in the closed circuit.

Divider 24 provides a barrier between the two closed circuits. The two closed circuits are independent of one another so that the food in the two ovens can be subject to heating programs independently of one another.

Control of the heating programs is undertaken automatically by a control unit mounted in the trolley with a key pad (not shown) for entering information locally. In the following details a range of four regenerators are specified of which the last three incorporate twin oven arrangements.

The “Minigen” and “Multigen” regeneration trolleys are designed to provide a bulk meal service combining simplicity of use and appealing presentation. The trolleys regenerate chilled and frozen food, with the oven temperature reaching 180° C., and keep food hot using a 13 amp supply.

The ‘Minigen II’ has two compartments—a 4 GN 1/1 oven chamber and a 4 GN 1/1 ambient section. Either or both sections can be refrigerated.

The ‘Multigen II’ has two compartments—an 8 GN 1/1 oven chamber and an 8 GN 1/1 ambient section. Either or both sections can be refrigerated.

The ‘Multigen III’ has two 8 GN 1/1 oven compartments—a total of 16×GN 1/1. Both sections can be refrigerated

The ‘Minigen’ & ‘Multigen’ trolleys are constructed from stainless steel 18/10. The heavy-duty base has reinforced channels and wrap round perimeter rubber bumper. With two ergonomically designed handles, the trolleys are mounted on four heavy-duty 160 mm double bearing castors with non-marking tyres—two fixed and two swivels with brakes. Easy maneuverability is assured by the cart's compactness and low weight. Special castor configuration allows the cart to turn easily through 360 degrees in a small turning circle. Door gaskets are easily removable and replaceable without the use of tools. Rounded internal chamber corners facilitate cleaning.

Unique dual independent forced air ventilation systems and temperature monitoring ensures different density products to be loaded in the same oven at the same time and be independently regenerated to the correct temperatures without spoiling delicate items. The ovens are able to gratinate, brown or fry food products.

The stainless steel heating element surrounded by high velocity fan ensures an even temperature throughout the chamber. They are designed to regenerate frozen foods to up to 180° C. Stainless steel GN 1/1 grids and are fitted with a non-tilting end stop and removable transfer modules. A blown air safety curtain over the oven door prevents heat or steam burns to operators. There is a door micro switch and a stay door catch.

Ventilated refrigeration is installed for the heated section and Static refrigeration via the cold wall section. There is a self contained CTC RI34A refrigerant.

The heated service top, with reinforced ridges, ensures food temperature maintenance during service. The heated service hot plate accommodates 4×GNI/1 or equivalent.

The Gantry has an LCD control panel and halogen infrared heated lights. There is a fully enclosed glass screen with top mounted guard mil for condiment containers. The optional cold light gantry has an LCD control panel.

The electronic control, with Liquid Quartz Display, offers the following functions:
three (3) heating cycle touch pads;
two service function pads for heated top and function button Count down timer;
cycle in progress, hot, cold and hot top temperatures LCD display;
audible alarm to indicate cycle completion;
error code display;
BCardWise HACCP monitoring system;
BCardWise user recognition;
sleep mode automatic cycle start timer with summer and winter time change food temperature monitoring linked to menu.
The ‘Minigen’ and ‘Multigen’ LCD control panel is fitted with a HACCP monitoring systems. It includes event list scroll menu displaying event times and temperatures. By means of the BCardWise+ up to 32 trolleys' events lists can be downloaded. In conjunction with BWise software, loaded on a PC, full historical data can be easily stored and managed.

Online Monitoring The BNetWise+ central real time monitoring system allows access to all trolleys, giving full control of cycle start and stop, event log, programming, trolley cycle status, etc. Networks for monitoring trolleys are via either Ethernet or WiFi networks

‘Minigen’ & ‘Multigen II’ EU Voltage: 400V-50 Hz 3P+N+E 7.8 KW 13 Amps—Refrig. I KW 4 Amps—Lights & Hot Top 1.5 KW 6 Amps 230V-SO Hz IP+N+E 2.8 KW 13 Amps-Refrig. I KW 4 Amps—Lights & Hot Top I.SKW 6 Amps

Units can be operated with both voltages by means of a cord set
NA Voltage: 208V-60 Hz 3P+N+E S 0.4 KW 16 Amps
120V-60 Hz 1P+N+E 1.7 KW 16 Amps.

Electrical components are fully fused.

Low voltage control panel class II for increased safety.

High temperature security thermostats.

Enclosed and ventilated electrical compartments.

Blown air curtain over oven door prevents heat or steam burns to operators.

Door micro switch.

Door stay open catch.

Inlet flange.

Cable.

Door handle

Lockable door handle

4-castor configuration—2 fixed, 2 swivel with brake

6-castor configuration—2 fixed, 4 swivel-2 with brake (not applicable to ‘Minigen II’)

Central brake for 4-castor configuration

Central brake for 6-castor configuration (not applicable to ‘Minigen II’)

Gantry with LCD controls and heated lights & guard rail

Gantry with LCD controls and cold lights & guard rail

ITS Racking
7 level module
8 level module
4 level module
Stainless steel grids-with anti-tilt feature S/S 304

Dolly with 2 or 3 compartments
Enclosed crockery transfer module
Docking system
Tow bar
Insulated cover
Dolly insert

Insulated Dolly—2 compartments
Docking system
Tow bar

Accessories Tray rail including cutlery cut-out. A condiment container can also be fitted on the gantry.
Side shelf with optional waste bag holder
Food probe or H.I. T food probe
Tow bar (4 castor configuration only)
Front fascia panel

Sanitation Removable ON 1/1 grids for easy cleaning.
Both chamber compartments are easily cleaned.
Wipe clean heated service hot plate.
Easy to clean sneeze screen.
Oven cleaning cycle

Weights 220 Kg estimated

Heat Output Oven 500 Btu/h
Refrigeration TBC Btu/h

Noise Level 53 Decibels TBC

### INDUSTRIAL APPLICABILITY

The invention provides an efficient regeneration unit made up of housing with two variable size working volumes in which two closely controlled cooking/regeneration processes can be undertaken independently of one another. Typically the unit can be controlled to provide for the regeneration process to be completed in respect of food stuffs contained in two separate compartments independently so that both the foodstuffs are ready to be served at a given time. Such a unit is capable of widespread use in a variety of catering applications including hospitals, air lines, organised entertainment, restaurants and residential organisations.

It will be apparent that invention can also be used with the partition removed as a single oven so that the combined air flows can be used to provide for a temperature and heating/cooling regime common to both parts. In this way the unit provides a versatile means for regeneration for a wide variety of catering environments including ones arising domestic, professional, commercial, travelling and institutional ones.

1.-5. (canceled)

6. A regeneration unit characterized by:
a housing;
a compartment in the housing being divided into first and second working volumes separated by a partition whose position within the compartment can be varied so as to vary relative sizes of the first and the second working volumes;
each working volume being incorporated in a closed flow path which incorporates: means for displacing air around the flow path; and heat transfer means for heating or cooling air displaced around the flow path; and
a control means whereby a flow of air displaced around a given closed flow path can be directed into the working volume associated with that flow path so that a temperature level and a time of heating or cooling of material contained in one of the first and the second working volumes is independent of a temperature level and a time of heating or cooling of material contained in the other of the first and the second working volumes.

7. The regeneration unit as claimed in claim 6, wherein the regeneration unit has programmable means for at least one of controlling and monitoring operation of the regeneration unit.

8. The regeneration unit as claimed in claim 6, wherein the regeneration unit is supported on castors or other mean to facilitate mobility of the regeneration unit.

9. The regeneration unit as hereinbefore described with reference to the accompanying drawings.

10. A regeneration unit characterized by:
a housing;
a compartment being located within the housing and the compartment being divided into first and second working volumes which are separated from one another by a movable partition whose position, within the compartment, is variable so as to vary relative sizes of the first and the second working volumes;
each of the first and the second working volumes having a closed flow path which incorporates a mechanism for displacing air around the flow path; and heat transfer mechanism for heating or cooling air displaced around the flow path; and
a control mechanism whereby a flow of air displaced around a given closed flow path can be directed into the working volume associated with that flow path so that a temperature level and a time of heating or cooling of material contained in one of the first and the second working volumes is independent of a temperature level and a time of heating or cooling of material contained in the other of the first and the second working volumes.

11. The regeneration unit as claimed in claim 10, wherein the regeneration unit has programmable mechanism for at least one of controlling and monitoring operation of the regeneration unit.

12. The regeneration unit as claimed in claim 10, wherein the regeneration unit is supported on castors which facilitate mobility of the regeneration unit.
